(19) United States
(12) Patent Application Publication
(10) Pub. No.: US 2024/0233100 A1
(43) Pub. Date: Jul. 11, 2024

(54) SYSTEMS AND METHODS FOR MULTI-SCALE LOCAL CONTRAST ENHANCEMENT

(71) Applicant: Meta Platforms Technologies, LLC, Menlo Park, CA (US)

(72) Inventors: Touraj Tajbakhsh, Carson City, NV (US); Hamidreza Mirzaei Domabi, Mountain View, CA (US); Andrey Tovchigrechko, Saratoga, CA (US)

(21) Appl. No.: 18/408,481

(22) Filed: Jan. 9, 2024

Related U.S. Application Data
(60) Provisional application No. 63/479,152, filed on Jan. 9, 2023.

(51) Int. Cl. G06T 5/94; G06T 5/20; G06T 5/70; G06T 5/92

(52) U.S. Cl. CPC G06T 5/94; G06T 5/20; G06T 5/70; G06T 5/92; G06T 2207/10024; G06T 2207/20016; G06T 2207/20192

(57) ABSTRACT

A circuitry-implemented method includes receiving an image pyramid of an image; convolving each level of the image pyramid with a kernel; constructing, based at least in part on the convolving of each level of the image pyramid, a base image pyramid; and generating a detail layer of the image by subtracting, from the image, a selected level of the base image pyramid from the image. Various other apparatuses, systems, and methods are also disclosed.

### CROSS REFERENCE TO RELATED APPLICATION

This application claims the benefit of U.S. Provisional Application No. 63/479,152, filed 9 Jan. 2023, the disclosures of each of which are incorporated, in their entirety, by this reference.

### BRIEF DESCRIPTION OF THE DRAWINGS

The accompanying drawings illustrate a number of example embodiments and are a part of the specification. Together with the following description, these drawings and appendices demonstrate and explain various principles of the present disclosure.

FIG. 1 is an illustration of an example image signal processing system.

FIG. 2 is an illustration of an example multi-scale local contrast enhancement system.

FIG. 3 is an illustration of the example multi-scale local contrast enhancement system in an example low-power mode.

FIG. 4 is an illustration of an example tone-mapping system.

FIG. 5 is an illustration of example global and local tile histogram generation.

FIG. 6 is an illustration of example tile overlapping in local tile histogram generation.

FIG. 7 is an illustration of an example thumbnail tile generation.

FIG. 8 is an illustration of an example local tone curves defined on a rectilinear grid.

FIG. 9 is an illustration of an example system for applying local contrast enhancement data.

FIG. 10 is an illustration of an example color correction system.

FIG. 11 is an illustration of an example chromaticity space.

FIG. 12 is an illustration of exemplary augmented-reality glasses that may be used in connection with embodiments of this disclosure.

FIG. 13 is an illustration of an exemplary virtual-reality headset that may be used in connection with embodiments of this disclosure.

FIG. 14 is an illustration of exemplary haptic devices that may be used in connection with embodiments of this disclosure.

FIG. 15 is an illustration of an exemplary virtual-reality environment according to embodiments of this disclosure.

FIG. 16 is an illustration of an exemplary augmented-reality environment according to embodiments of this disclosure.

FIG. 17 an illustration of an exemplary system that incorporates an eye-tracking subsystem capable of tracking a user's eye(s).

FIG. 18 is a more detailed illustration of various aspects of the eye-tracking subsystem illustrated in FIG. 17.

FIGS. 19A and 19B are illustrations of an exemplary human-machine interface configured to be worn around a user's lower arm or wrist.

FIGS. 20A and 20B are illustrations of an exemplary schematic diagram with internal components of a wearable system.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within this disclosure.

### DETAILED DESCRIPTION OF EXAMPLE EMBODIMENTS

The human visual system (HVS) is highly adept at perceiving information across a broad spectrum of lighting conditions, including extreme conditions. The HVS is capable of discerning a wide luminance range, approximately spanning 14 logarithmic units. This range equates to about 48 bits in digital terms, providing a very high sensitivity to varying light levels.

In contrast, some digital displays may cover a significantly smaller range, such as 8 bits (or 2.4 logarithmic units). This limitation means that these digital displays may be unable to replicate the full dynamic range of luminance that the human eye can perceive.

Imaging devices, such as cameras, may partly adapt to different lighting conditions by adjusting parameters like exposure and light sensitivity. Despite these adjustments, imaging devices may fail to capture the entire dynamic range present in a scene. This failure may lead to lost details in both very bright and very dark areas of an image.

Local contrast enhancement (LCE) aims to address this disparity. LCE may enhance the contrast in images to more closely match the capabilities of the target display device, while also attempting to maintain the contrast perceived in the original scene. LCE may thus work to bridge the gap between the dynamic range capabilities of imaging devices (e.g., the combined dynamic range of the imager and the image signal processor (ISP)) and the more limited range of display technologies. The goal is to faithfully reproduce the visual experience of the original scene—including the apparent contrast—despite the technical limitations of imaging and display systems.

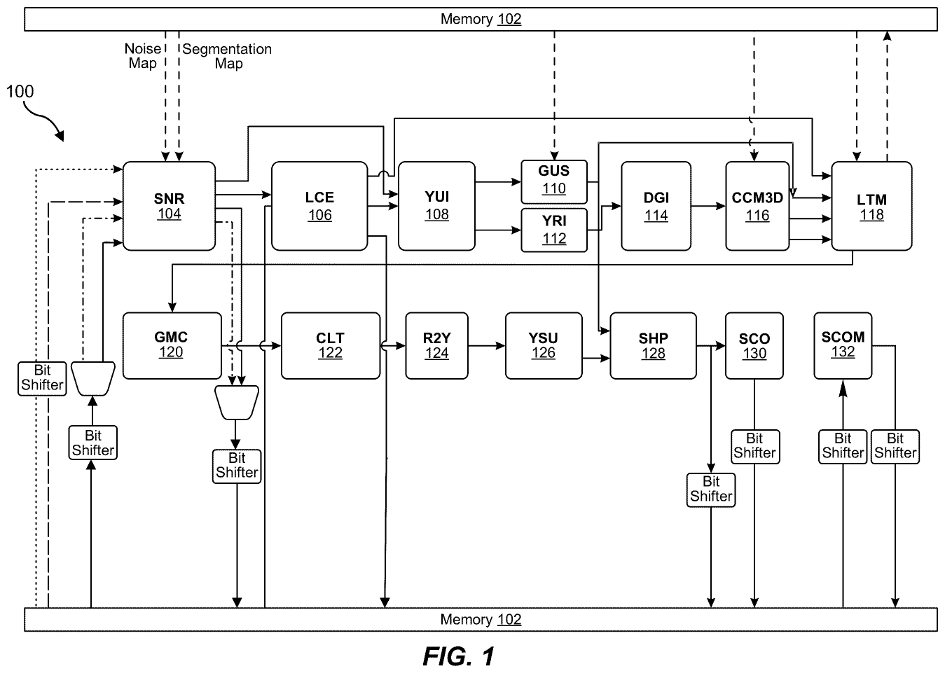

FIG. 1 is an illustration of an example image signal processing (ISP) system 100. In particular, FIG. 1 illustrates various blocks in a color processing sub-pipeline. In general, each block of system 100 may modify, transform, and/or convert an image as it progresses through the pipeline. As will be explained in greater detail below, in some examples, system 100 may include a memory 102 and a pipeline of several blocks, including a Spatial Noise Reduction (SNR) block 104, a Local Contrast Enhancement (LCE) block 106, a conversion block 108, a Guided Upscaler (GUS) block 110, a conversion block 112, a De-gamma (DGI) block 114, a Color-Correction (CCM3D) block 116, a Local Tone Mapping (LTM) block 118, a Gamma Correction (GMC) block 120, a Color Look-up Table (CLT) block 122, a conversion block 124, a conversion block 126, a Sharpener (SHP) block 128, a scaler block 130, and a scaler block 132.

In one example, SNR block 104 may reduce noise in the image by e.g., averaging out pixel values across a spatial area. This may smooth the image and reduce graininess (e.g., as may be caused by low light conditions). In one example, as will be discussed in greater detail below, SNR block 104 may use a multi-scale technique to reduce noise. For example, SNR block 104 may use an image pyramid. As used herein, the term “image pyramid” generally refers to a series of progressively lower resolution copies of an image. In some examples, SNR block 104 may use a Gaussian pyramid. As used herein, the term “Gaussian pyramid” generally refers to a series of progressively lower resolution copies of an image to which a Gaussian filter has been applied. For example, SNR block 104 may for each level of the Gaussian pyramid, first smooth the level using a Gaussian filter, and then subsample the level to produce the next level of the pyramid.

After constructing the Gaussian pyramid and applying noise reduction at each level of the Gaussian pyramid, SNR block 104 may combine the levels of the Gaussian pyramid to reconstruct a noise-reduced version of the image. For example, SNR block 104 may upsample and merge the images from each level of the pyramid. In some examples, the higher-resolution levels may retain more of the original image detail, while the lower-resolution levels may contribute to the smoothness and noise reduction of the image. In some examples, use of the Gaussian pyramid by SNR block 104 may effectively preserve details of the image while reducing noise.

As will be explained in greater detail below, while SNR block 104 may generate and use the Gaussian pyramid, in some examples the same Gaussian pyramid generated by SNR block 104 may be reused by one or more additional blocks later in the pipeline of system 100. For example, SNR block 104 may pass the Gaussian pyramid to LCE block 106. For example, SNR block 104 may stream a denoised pyramid of luminance channels of the image to LCE block 106.

LCE block 106 may enhance local image contrast of the image using a pyramidal multi-scale architecture. This may allow a large receptive field when processing the image while at the same time avoiding a large footprint of local memory. In some examples, LCE block 106 may carry out a Gaussian pyramid decomposition using read and writes from external memory and may operate to sustain a sufficient number of frames per second (e.g., 60 frames per second or more) for real-time streaming applications.

In some examples, LCE block 106 may perform a set of edge-preserving sharpening convolutions operating at different scales. LCE block 106 may then combine the results of these convolutions in a bottom-up order. LCE block 106 may successively decomposes a Gaussian image pyramid into base and detail layers and may reconstruct two high-resolution base and detail image layers. As will be explained in greater detail below, LCE block 106 may transmit the detail layer of the image and the base layer of the image to LTM block 118, where the detail layer may be adjusted based on the tone-mapping operation of LTM block 118 and may then be aggregated with the tone-mapped output luminance image.

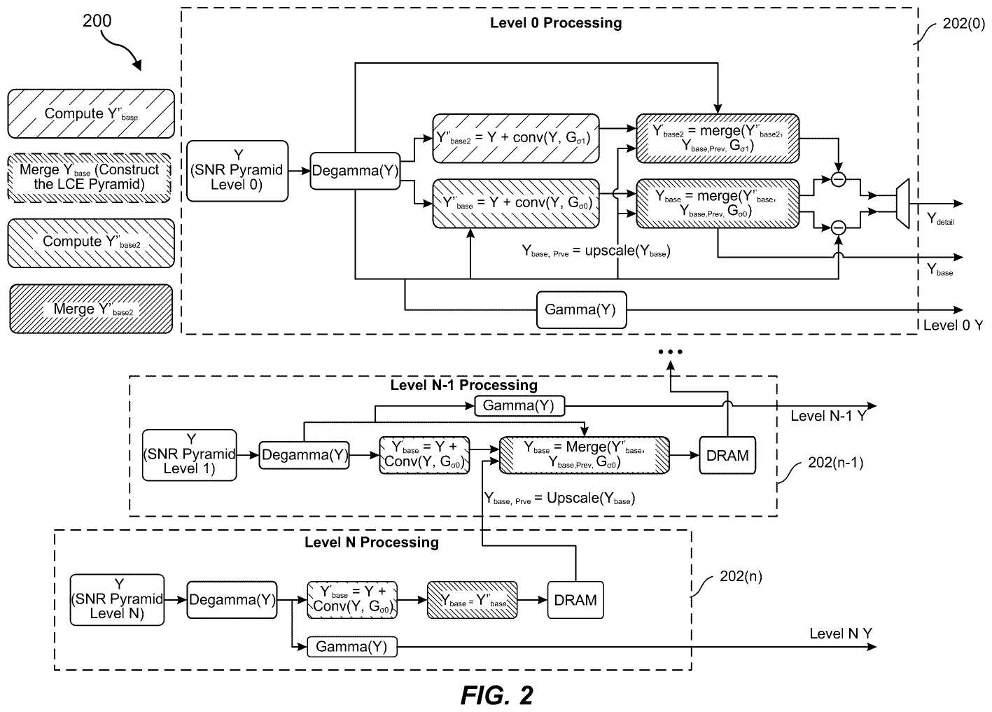

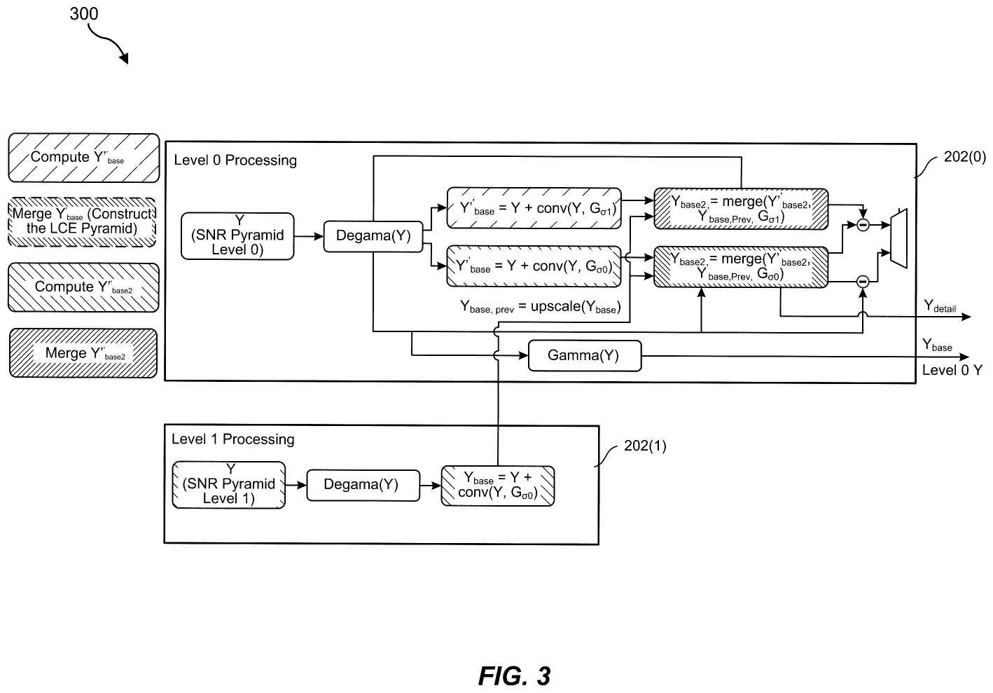

Examples of LCE block 106 will be provided in connection with the description of FIGS. 2 and 3 below.

In some examples, conversion block 108 may convert the image from one format to another format. For example, conversion block 108 may convert the image to a format that stores more color information (e.g., to improve the quality of color processing). In one example, conversion block 108 may convert the image from the YUV420 format to the YUV444 format.

In some examples, GUS block 110 may use guidance data (e.g., a high-resolution image) to interpolate the image and improve its quality.

In some examples, conversion block 112 may convert the image from one color space to another color space. For example, conversion block 112 may convert the image from YUV color space to Red, Green, Blue (RGB) color space.

In some examples, DGI block 114 may remove gamma correction from the image.

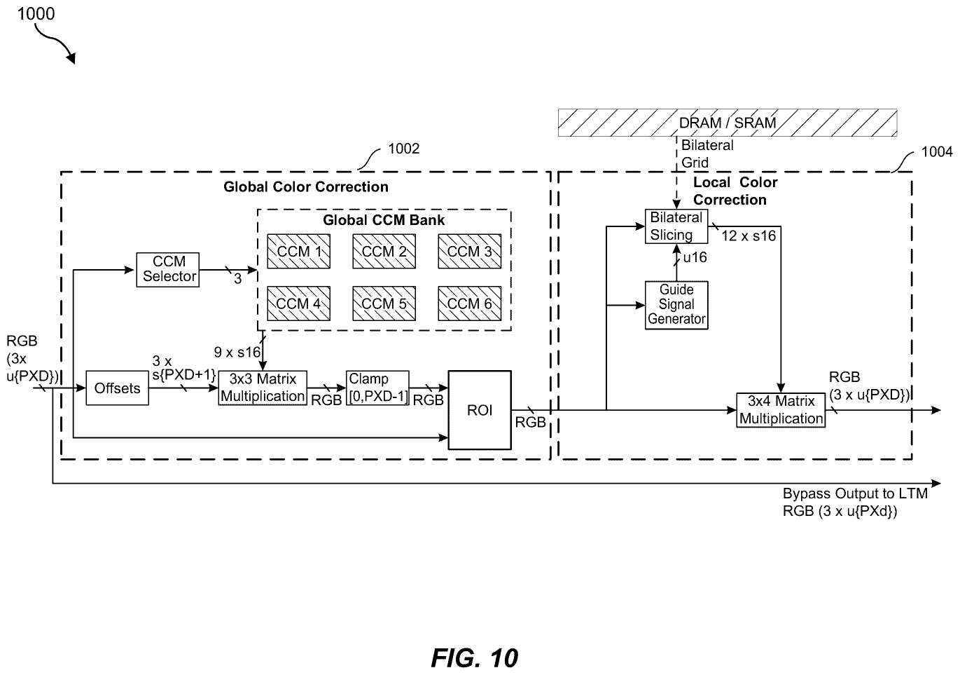

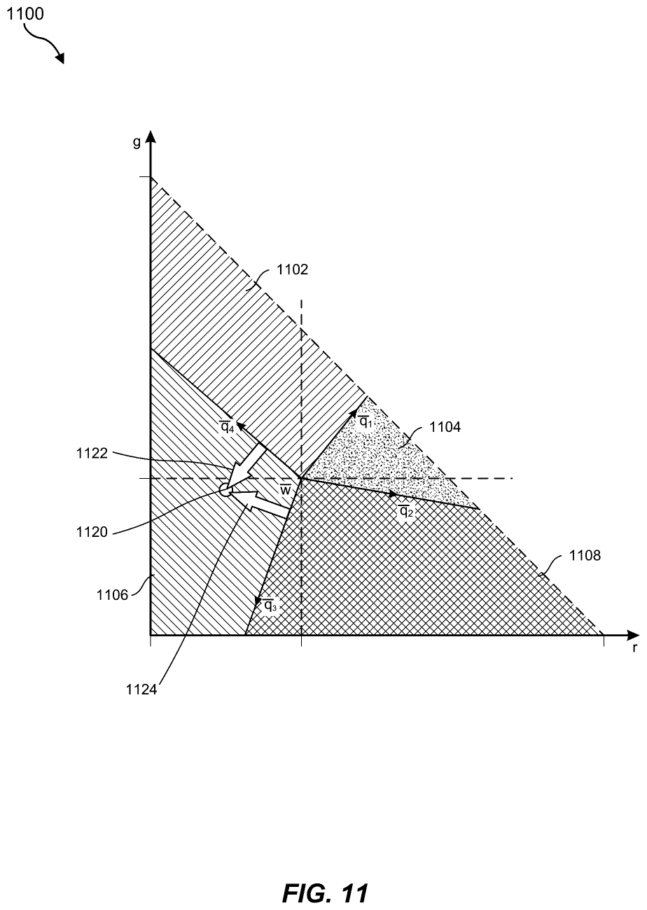

CCM3D block 116 may perform one or more color-correction and/or color-effect operations on the image. For example, CCM3D block 116 may apply a spatially and intensity-variant color correction matrix to the image. In some examples, CCM3D block 116 may apply global and local color-correction transformations to an RGB stream based on the locations and intensities of component pixels. In some examples, global transformations may be based on one of several firmware-configured color-correction matrices stored in local memory. In some examples, local transformations may be based on linear-color-correction matrices derived from external memory. Examples of CCM3D block will be provided in connection with the description of FIGS. 10 and 11 below.

LTM block 118 may adjust the tonal range of the image. In some examples, LTM block 118 may enhance the global appearance and the local contrast of the image. For example, LTM block 118 may enhance the visibility of fine textures as well as tones in shadow and highlight regions of the image without losing control over the amplification of visible noise. In some examples, LTM block 118 may also mitigate an elevated black point and reduced contrast (e.g., as may be caused by lens flare). As mentioned earlier, LTM block 118 may receive base and detail layers of the image from LCE block 106 and may use these auxiliary luminance images during tone mapping to improve local image contrast. In some examples, the aggregation of the information from LCE block 106 by LTM block 118 may rely on one or more HVS characteristics obtained from psychophysical data.

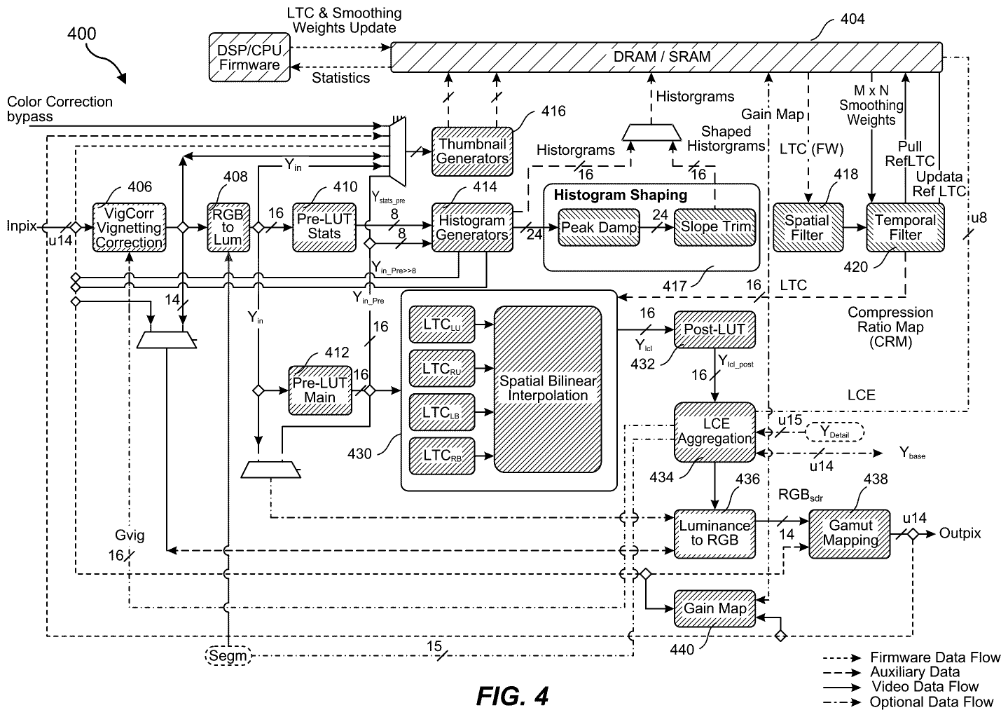

In some examples, LTM block 118 may generate image statistics for frame-by-frame computing and application of adaptive global and local tone curves. LTM block 118 may include sub-blocks for performing vignetting correction, LCE aggregation, gamut mapping, local tone-curve mapping, integral-map generation, thumbnail generation, and/or histogram shaping. Additional description of LTM block 118 will be provided in connection with the description of FIGS. 4-9 below.

In some examples, GMC block 120 may apply gamma correction to the image (e.g., to adjust the luminance of the image for the specific characteristics of a target display device).

In some examples, CLT block 122 may transform the color values of the image, e.g., by applying a look-up table (LUT). In some examples, CLT block 122 may apply complex color adjustments in a non-linear manner.

In some examples, R2Y block 124 may convert the image from one color space to another color space. For example, R2Y block 124 may convert the image from the RGB color space back to the YUV color space.

In some examples, conversion block 126 may convert the image from one format to another. For example, conversion block 126 may convert the image from the YUV444 format back to the YUV420 format.

In some examples, SHP block 128 may sharpen the image (e.g., by enhancing edges within the image). Additionally or alternatively, SHP block 128 may apply a low pass filter for the chroma components of the image (e.g., to reduce chroma noise).

In some examples, scaler blocks 130 and 132 may scale the image (e.g., for output on a target display size).

As may be appreciated, system 100 provides an example of an image signal processing pipeline, and various systems, devices, and modules described herein may include and/or form a part of an image signal processing pipeline with differing configurations, including different blocks and/or different orderings of blocks. Thus, for example, the blocks of system 100 may be arranged in a pipeline in any suitable order and, in some examples, may include one or more additional blocks and/or may exclude one or more blocks.

In some examples, LCE block 106 may follow SNR block 104 in the pipeline (and, e.g., reduce a Gaussian pyramid generated by SNR block 104). In some examples, LTM block 118 may come after LCE block 106 in the pipeline (and may use a detail layer and a base layer provided by LCE block 106, allowing LTM block 118 to adjust the detail layer in light of tone-mapping data and then aggregate the detail layer with the tone-mapped image. In some examples, CCM3D block 116 may come between LCE block 106 and LTM block 118 and LCE block 106 may provide the detail layer directly to LTM block 118, bypassing CCM3D block 116.

FIG. 2 is an illustration of an example multi-scale local contrast enhancement system 200. As shown in FIG. 2, system 200 performs processing at multiple levels (e.g., levels 202(0)-202(n).

In one example, system 200 may receive a pyramid of denoised luma-channel images (e.g., a Gaussian pyramid from a noise reduction block, such as SNR 104 in FIG. 1). Each processing level 202(0)-202(n) may process a corresponding level of the pyramid. As represented in FIG. 2, Y in a given processing level may denote the streamed denoised luma-channel image at that processing level. As shown in FIG. 2, system 200 may construct two auxiliary layers of the image, Y_{detail} and Y_{base}. In order to construct these auxiliary layers, system 200 may begin by processing the input luma pyramid from the lowest resolution level (e.g., level 202(n)) and may construct a Y_{base} pyramid, where Y_{base} represents a luma image from which texture is removed.

In order to construct the Y_{base} pyramid, at each processing level, system 200 may convolve a kernel (e.g., a 5×5 filter) on the input Y. As represented in FIG. 2, this results in a temporary single-level convolution result Y′_{base}. Afterwards, the current level of the Y_{base} pyramid is computed by combining the current Y′_{base} with an upsampled Y_{base} from the lower level, denoted as Y_{base,prev}. Thus, the current level of the pyramid is consumed by the higher levels of the pyramid. At the desired resolution scale, system 200 may determine Y_{detail} by subtracting it from Y.

In some examples, the function Gσ0 weights the contribution of each neighboring pixel in a 5×5 region and returns large weights for small differences and small weights for large gradients. For example, the function may be a decaying Gaussian with a range threshold σ0 that controls the amount of down weight of a pixel contribution based on its intensity difference.

In some examples, system 200 may compute a bandpass filter of Y (at the same pyramid level as where Y_{detail} is computed) to avoid amplifying the high frequency noise along with textures. First, system 200 may compute another convolution image Y′_{base2} (with a smaller range threshold σ than for Y′_{base2}). System 200 may then merge Y′_{base2} with the Y_{base,prev}. System 200 may use Gσ1 with range threshold σ1 where σ1<σ0 which, resulting in Y_{base2}, which is sharper than Y_{base}. In this case system 200 may compute the detail layer as a bandpass filter Y_{detail}=Y_{base2}−Y_{base}. This results in a noise-suppressed detail layer.

In some examples, system 200 may perform a bottom-up processing from memory to memory. For all processing levels (except for level 202(0)), the computed Y_{base} may be written to memory. Upper processing levels may read and consume the outputs of the lower processing levels to perform their own computation. This process may continue until the desired resolution level (e.g., full resolution of the original image), at which point system 200 may compute Y_{detail}. At this level, Y_{base} and Y_{detail} may not be written to memory, but instead transmitted (along with the YUV/RGB pixel values) to another block (e.g., to LTM block 118 of FIG. 1).

FIG. 3 is an illustration of an example multi-scale local contrast enhancement system 300 in an example low-power mode. As shown in FIG. 3, only processing levels 202(0) and 202(1) may be applied. As shown in FIG. 3, the Y_{base} output of level 202(1) may not be streamed to memory, but instead connected directly to level 202(0).

FIG. 4 is an illustration of an example tone-mapping system 400. As shown in System 400, tone-mapping system 400 may include a vignetting correction block 406. For example, an imaging device may limit the amount of light that can be captured at off-axis photodetector sites, causing a light falloff compared to the center of the sensor array. This may result in a gradual decreased in light intensity towards the image periphery. Accordingly, in some examples, block 406 may apply a variant pixel gain (e.g., a radially-variant pixel gain) to the incoming RGB pixels.

In some examples, block 406 may apply non-linear gains to mitigate the risk of pixels values that exceed a color component clipping threshold causing hue shifts in color. For example, block 406 may perform a linear gain, and then divide the component value by a soft-clipping term to limit amplification.

System 400 may also include an RGB-to-Luminance block 408. In some examples, block 408 may map tones of pixels in the luminance domain.

System 400 may also include a pre-processing look-up table (LUT) block 412. In some examples, block 412 may transform the luminance to a non-linear space (e.g., logarithmic) and allow sample points for tone mapping to be centered at the histogram bins.

In some examples, system 400 may collect one or more types of image statistics (e.g., at a statistics collection block 410). For example, system 400 may collect local tile luminance histograms, one or more global histograms (e.g., an accumulating luminance and an accumulating RGB), and one or more low-resolution thumbnail generators (e.g., two thumbnail generators). In addition, as will be explained in greater detail below, the global and local histograms may in some examples, undergo histogram shaping.

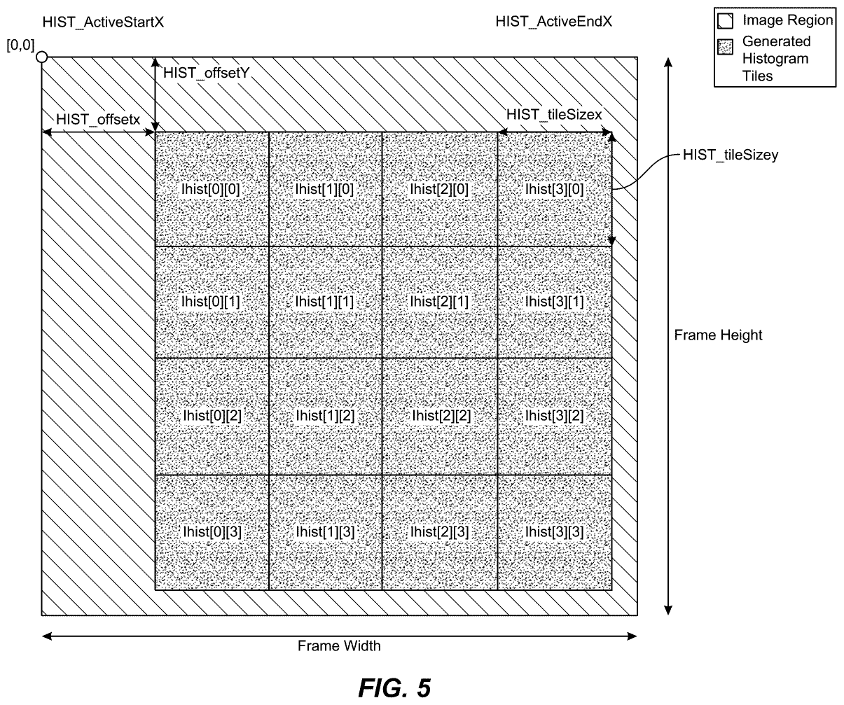

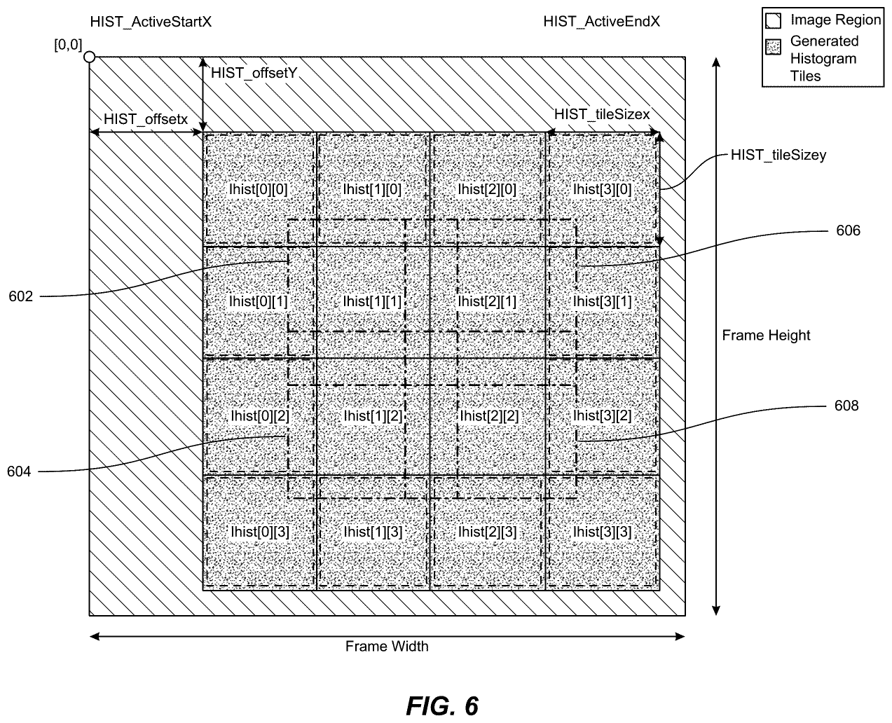

System 400 may also include a histogram generation block 414. In some examples, block 414 generate local tile histograms for a specified number of tiles, a specified tile size, and/or a specified offset within the image region. For example, as shown in FIG. 5, an example local histogram tiling may include a 4×4 grid of tiles of a specified size offset within the larger image region. In some examples, block 414 may provide for overlapping tiles (e.g., the histogram generation for a tile may include portions of neighboring tiles). For example, as shown in FIG. 6, an example overlapping local histogram tiling may include overlap areas 602, 604, 606, and 608 for the four respective inner tiles.

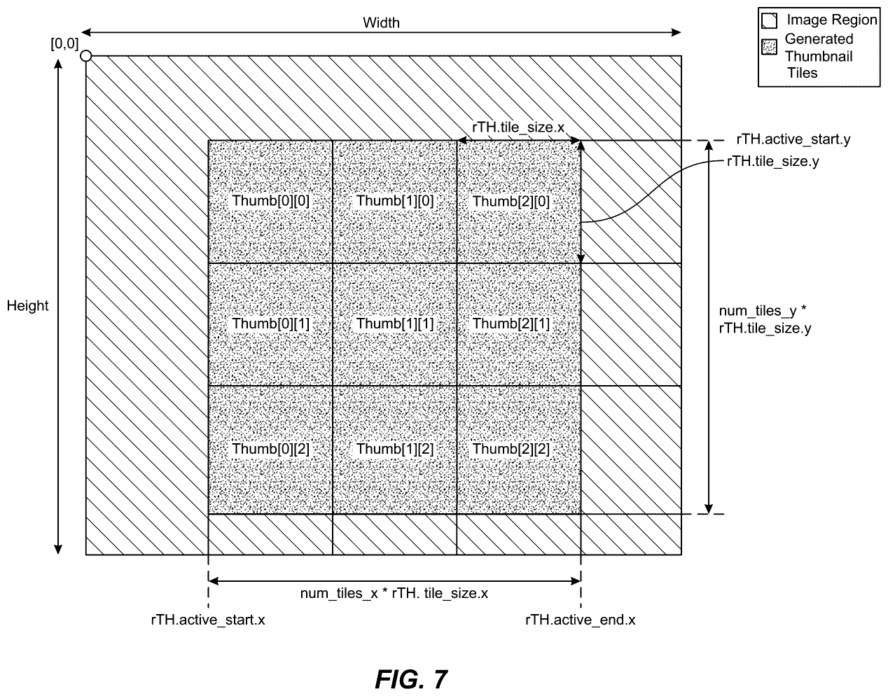

Returning to FIG. 4, system 400 may also include a thumbnail generation block 416 with one or more thumbnail generators. In some examples, block 416 may generate thumbnails that are the normalized sum of pixel values within a tile of the full resolution image. As shown in FIG. 7, block 416 may generate a specified grid of thumbnail tiles at a specified size within a specified active region of the image.

In some examples, system 400 may also include a histogram shaping block 417. In various examples, histogram shaping block 417 may perform histogram normalization, peak damping, and/or slope trimming of the histograms generated by block 414. For example, block 417 may perform peak damping by reducing peak-to-valley distances in the histogram and, thus, lessening the amount of histogram equalization that is obtained when processing a normalized cumulative histogram. Block 417 may performing slope trimming by limiting the slopes of the cumulative histogram, thereby constraining histogram equalization.

In some examples, system 400 may include a spatial filter block 418 and a temporal filter block 420. For example, system 400 may read local tone curves from a memory 404. Block 418 may perform spatial filtering on the local tone curves and block 420 may perform temporal filtering on the local tone curves. A spatial bilinear interpolation block 417 may then consume the filtered local tone curves and map incoming luminances based on the pixel's spatial location. A luminance-to-color block 436 may then use the mapped luminances to tone-map input RGB pixels. A gamut mapping block 438 may prevent mapped color components from exceeding the value range while preserving color hue and trading off luminance and saturation.

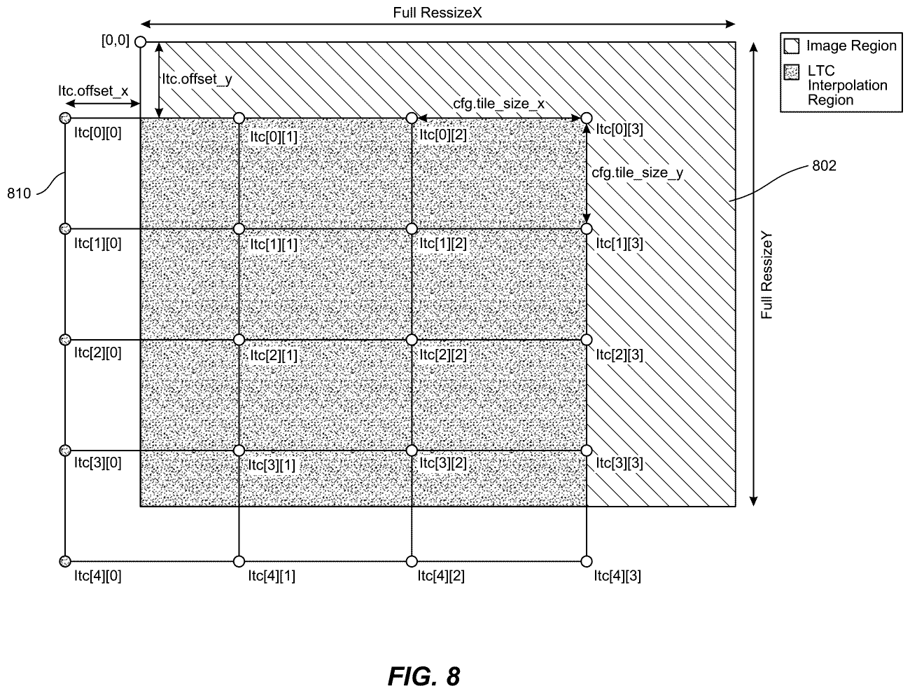

As mentioned above, block 430 may consume local tone curves (e.g., filtered by blocks 418 and 420). In some examples, and as shown in FIG. 8, block 430 may define local tone curves on a rectilinear grid 810 spanned over an image frame 802. Block 430 may tone map each pixel using the local tone curves defined on the four nearest points of the rectilinear grid.

Returning to FIG. 4, system 400 may include a post-processing LUT block 432. In some examples, block 432 may apply a post-processing LUT and piecewise linear interpolation on the luminance values from the spatial interpolation from block 430.

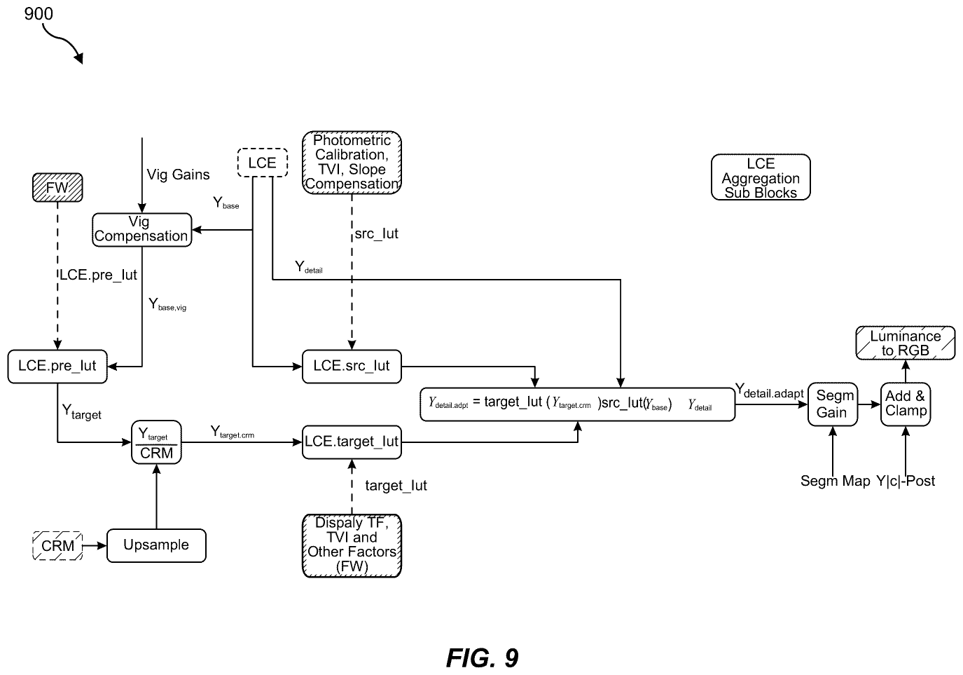

System 400 may also include a Local Contrast Enhancement Aggregation block 434. As mentioned earlier, a detail layer (Y_{detail}) and a base layer (Y_{base}) of the image may be provided by an earlier block in the image signal processing pipeline, such as LCE 106 in FIG. 1. In some examples, block 434 may first adjust Y_{detail}. FIG. 9 illustrates a system 900 as an example of block 434. As shown in FIG. 9, system 900 may produce the adjusted Y_{detail} (Y_{detail_adapt}) based on Y_{detail}, Y_{base}, a compression-ratio map (CRM) specifying dynamic range compression that occurred in the image, and the post-processed luminance image from block 432 (Ylcl_post). System 900 may then aggregate Y_{detail_adapt} to Ylcl_post. To determine Ylcl_post, system 900 may compute an adjustment ratio of the adapting luminances (targetFactor/srcFactor). System 900 may then multiply the adjustment ratio by to transform the local contrast values from the source domain (before tone mapping) to the target domain (after tone mapping).

To compensate for the vignetting correction gains from block 406, system 900 may compute a vignetting corrected version of Y_{base} (Y _{baseVig}). The vignetting compensation gains (G_{vig_lce}) are the same as the gains applied in block 406 (G_{vig}). In some examples, system 900 may refine G_{vig_lce} with a piecewise linear interpolation based on a LUT. Once system 900 computes the G_{vig_lce} gains, system 900 may apply G_{vig_lce} to Y_{base}.

System 900 may further refine Y_{detail} by using the input segmentation map. Based on the pixel category, system 900 may apply a gain to amplify or decrease the Y_{detail} signal.

In some examples, System 900 may perform a bilinear upscaling of the CRM to obtain a full resolution compression ratio map. The size of the full-resolution CRM may be the same as the full resolution image.

Returning to FIG. 4, block 438 may perform color gamut mapping on the image. The pixel gain applied at block 436 may cause color components to go out of range and thus alter the hue and saturation of the pixel. Thus, block 438 may ensure that the hue of the original input RGB pixel is preserved along with the luminance or saturation of the tone-mapped pixel.

System 900 may also include a gain map block 440. In some examples, block 440 may deliver a gain map of the image to memory.

FIG. 10 is an illustration of an example color correction system 1000. As shown in FIG. 10, system 100 may include a global color correction block 1002 and a local color correction block 1104. In some examples, block 1002 may, for each pixel, select a color correction matrix (CCM) to apply to the pixel from a set of candidate CCMs (e.g., from a bank of 6 CCMs).

Block 1002 may select the color correction matrix in any suitable manner. For example, block 1002 may partition a chromaticity space (or identify a partitioned chromaticity space), where each partition in the chromaticity space corresponds one of the candidate CCMs. Block 1002 may then identify a location of a pixel within the chromaticity space. Block 1002 may determine which partition of the chromaticity space that the pixel falls in and may select the CCM that corresponds to that partition. Block 1002 may determine which partition the pixel falls in in any suitable manner. For example, Block 1002 may calculate the normal of the pixel with respect to the boundaries of the partitions and identify the partition whose boundaries both produce a normal for the pixel directed into the partition.

FIG. 11 is an illustration of an example chromaticity space 1100. As shown in FIG. 11, space 1100 may be divided into multiple partitions (shown as four partitions in FIG. 11, but which in some examples may instead be, e.g., six partitions, matching the number of candidate CCMs shown in FIG. 10). In one example, a pixel may correspond to a location 1120 within space 1100. Systems described herein may determine that the pixel falls within partition 1106. For example, these systems may compute the normals of the pixel with respect to the various partition boundaries. Thus, for example, these systems may compute the normal 1122 of the pixel and the normal 1124 of the pixel with respect to the boundaries of partition 1106. These systems may then determine that normals 1122 and 1124 both point inward toward partition 1106 and determine, based on normals 1122 and 1124 both pointing inward toward partition 1106, that location 1120 is within partition 1106.

Returning to FIG. 10, In some examples, block 1004 may generate a scalar guide signal based on an RGB value of each pixel and use the guide signal to produce, from a bilateral grid of matrices through depth-wise slicing, four CCMs, and perform a bilinear interpolation of the four CCMs. For example, CCMs may be defined on a rectilinear grid spanned over the image frame. For each pixel, block 1004 may use the four nearest CCM grid points. Block 1004 may multiply the pixel with each of the four depth-wise sliced candidate CCMs and may bilinearly interpolate the final pixel.

One or more circuitry-implemented methods may be implemented with one or more integrated circuits, firmware modules, and/or processors executing memory-stored instructions. In one example, a circuitry-implemented method may include receiving an image pyramid of an image; convolving each level of the image pyramid with a kernel; constructing, based at least in part on the convolving of each level of the image pyramid, a base image pyramid; and generating a detail layer of the image by subtracting, from the image, a selected level of the base image pyramid from the image.

In one example, a noise reduction module may have previously used the image pyramid to perform a noise reduction operation; and receiving the image pyramid may include receiving the image pyramid from the noise reduction module without regenerating the image pyramid.

In one example, constructing the base image pyramid may include using a convolved initial level of the image pyramid as an initial level of the base image pyramid; and for each successive additional level of the base image pyramid, merging a corresponding convolved level of the image pyramid with an upscaled version of a previous level of the base image pyramid.

In one example, the image pyramid includes a Gaussian pyramid. In one example, the image pyramid includes a luma pyramid of the image.

In one example, the method may further include receiving an additional image pyramid of an additional image; in response to detecting a low-power mode, convolving a subset of levels of the additional image pyramid with the kernel; constructing, based at least in part on the convolving of the subset of levels of the additional image pyramid, an additional base image pyramid; and generating a detail layer of the image by subtracting, from the image, a selected level of the base image pyramid from the image.

In one example, the method may further include generating an enhanced image with an increased level of detail by applying the detail layer to the image.

In one example, the method may further include transmitting the image to a color correction module that enhances the image by applying color correction to the image.

In one example, the method may further include transmitting the detail layer directly to a tone-mapping module by bypassing the color correction module, where the tone-mapping module: receives the image as enhanced by the color correction module; applies a tone-mapping process to the image to further enhance the image; and applies the detail layer after the tone-mapping process to further enhance the image.

In one example, the method may further include receiving an additional image pyramid of an additional image; in response to detecting a low-power mode, convolving a subset of levels of the additional image pyramid with the kernel; constructing, based at least in part on the convolving of the subset of levels of the additional image pyramid, an additional base image pyramid; and generating a detail layer of the image by subtracting, from the image, a selected level of the base image pyramid from the image.

In another example, a circuitry-implemented method may include receiving a set of statistical moments of an image; calculating a global tone curve based on the set of statistical moments; receiving a set of local histogram statistics of the image; generating a set of local tone curves based on the set of local histogram statistics; and applying first the global tone curve and then the set of local tone curves to the image.

In one example, applying the set of local tone curves to the image includes: updating a set of look-up tables for a set of tiles of the image with the set of local tone curves; and performing a spatial bilinear interpolation on the image based on the set of look-up tables updated with the set of local tone curves.

In one example, the global tone curve maps luminance values to luminance values.

In one example, the method further includes shaping the set of local histogram statistics by performing at least one of: a peak damping operation; or a slope trimming operation.

In one example, the method further includes performing a vignetting reduction operation on the image before applying the global tone curve and the set of local tone curves to the image.

In one example, the vignetting reduction operation applies a non-linear gain to vignetted areas of the image.

In one example, the vignetting reduction operation applies the non-linear gain constrained to prevent clipping due to out-of-range values.

In one example, the method further includes applying a detail layer to the image after applying the global tone map and the set of local tone maps to the image.

In one example, the method further includes performing gamut mapping on the image to preserve a set of original hues of the image.

In one example, the gamut mapping is performed after applying the global tone map and the set of local tone maps to the image; and the set of original hues for the gamut mapping are derived from the image before the vignetting reduction operation.

In another example, a circuitry-implemented method may include: performing a global color correction operation on an image by receiving a stream of pixels and, for each pixel in the stream of pixels: determining a hue of the pixel; selecting one of a set of color correction matrices based on the hue of the pixel; and applying the selected color correction matrix to the pixel.

In one example, each of the set of color correction matrices corresponds to a different partition of a chromaticity space.

In one example, selecting one of the set of color correction matrices based on the hue of the pixel includes determining that the hue of the pixel falls within a partition of the chromaticity space corresponding to the selected color correction matrix.

In one example, determining that the hue of the pixel falls within the partition of the chromaticity space corresponding to the selected color correction matrix includes: calculating a first normal of a position of the hue within the chromaticity space relative to a first boundary of the partition; calculating a second normal of the position of the hue within the chromaticity space relative to a second boundary of the partition; and determining that the first normal and the second normal both point toward the partition.

In one example, the set of color correction matrices are selected to produce continuous results at partition boundaries of the chromaticity space.

In one example, the method further includes performing a local color correction operation on each pixel by: generating a scalar guide signal based on a Red, Green, Blue (RGB) value of the pixel; deriving a local color correction matrix from a bilateral grid of matrices based on the scalar guide signal; and applying the local color correction matrix to the pixel.

In one example, the bilateral grid of matrices is generated using a machine learning model.

In one example, the bilateral grid is configured to perform at least one of the following: a contrast manipulation operation; a color manipulation operation; a tone manipulation operation; a recolorization operation; or a noise reduction operation.

In one example, the method further includes generating a thumbnail of the image; and providing the thumbnail as input to a machine learning model to generate the bilateral grid.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

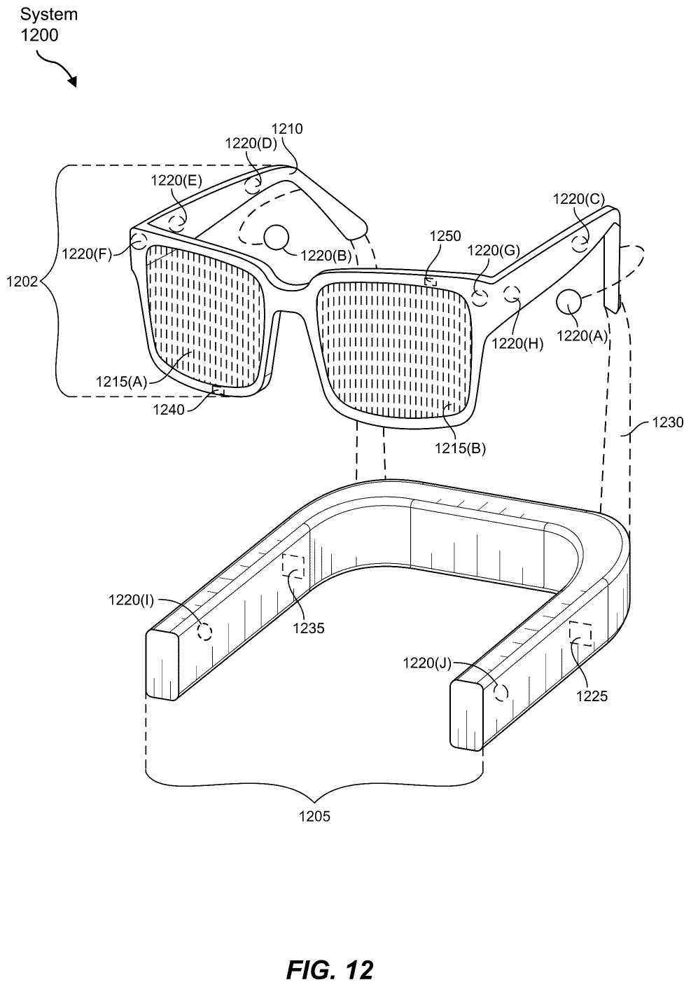

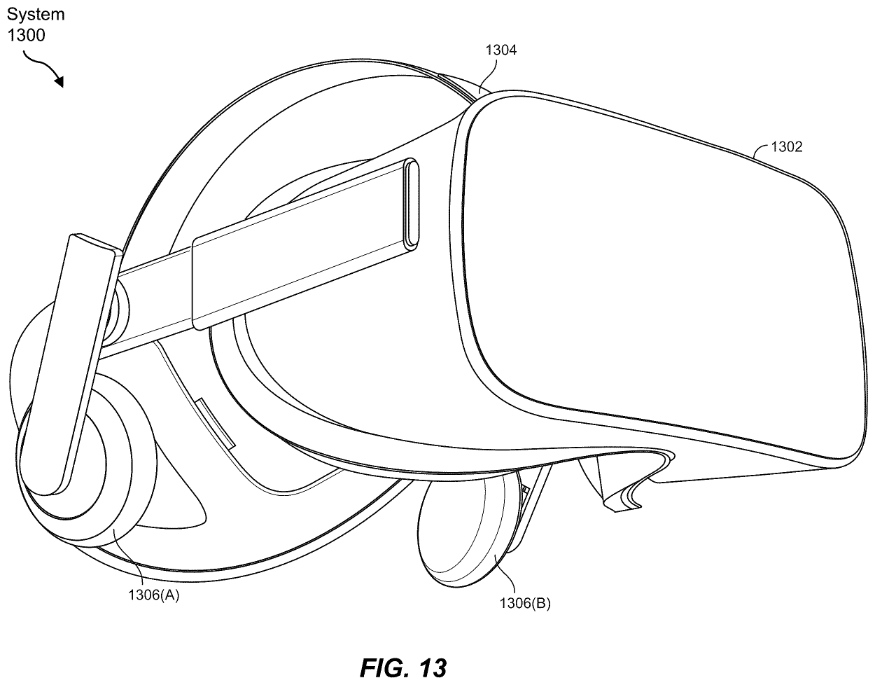

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1200 in FIG. 12) or that visually immerses a user in an artificial reality (such as, e.g., virtual-reality system 1300 in FIG. 13). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 12, augmented-reality system 1200 may include an eyewear device 1202 with a frame 1210 configured to hold a left display device 1215(A) and a right display device 1215(B) in front of a user's eyes. Display devices 1215(A) and 1215(B) may act together or independently to present an image or series of images to a user. While augmented-reality system 1200 includes two displays, embodiments of this disclosure may be implemented in augmented-reality systems with a single NED or more than two NEDs.

In some embodiments, augmented-reality system 1200 may include one or more sensors, such as sensor 1240. Sensor 1240 may generate measurement signals in response to motion of augmented-reality system 1200 and may be located on substantially any portion of frame 1210. Sensor 1240 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1200 mayor may not include sensor 1240 or may include more than one sensor. In embodiments in which sensor 1240 includes an IMU, the IMU may generate calibration data based on measurement signals from sensor 1240. Examples of sensor 1240 may include, without limitation, accelerometers, gyroscopes, magnetometers, other suitable types of sensors that detect motion, sensors used for error correction of the IMU, or some combination thereof.

In some examples, augmented-reality system 1200 may also include a microphone array with a plurality of acoustic transducers 1220(A)-1220(J), referred to collectively as acoustic transducers 1220. Acoustic transducers 1220 may represent transducers that detect air pressure variations induced by sound waves. Each acoustic transducer 1220 may be configured to detect sound and convert the detected sound into an electronic format (e.g., an analog or digital format). The microphone array in FIG. 12 may include, for example, ten acoustic transducers: 1220(A) and 1220(B), which may be designed to be placed inside a corresponding ear of the user, acoustic transducers 1220(C), 1220(D), 1220(E), 1220(F), 1220(G), and 1220(H), which may be positioned at various locations on frame 1210, and/or acoustic transducers 1220(I) and 1220(J), which may be positioned on a corresponding neckband 1205.

In some embodiments, one or more of acoustic transducers 1220(A)-(J) may be used as output transducers (e.g., speakers). For example, acoustic transducers 1220(A) and/or 1220(B) may be earbuds or any other suitable type of headphone or speaker.

The configuration of acoustic transducers 1220 of the microphone array may vary. While augmented-reality system 1200 is shown in FIG. 12 as having ten acoustic transducers 1220, the number of acoustic transducers 1220 may be greater or less than ten. In some embodiments, using higher numbers of acoustic transducers 1220 may increase the amount of audio information collected and/or the sensitivity and accuracy of the audio information. In contrast, using a lower number of acoustic transducers 1220 may decrease the computing power required by an associated controller 1250 to process the collected audio information. In addition, the position of each acoustic transducer 1220 of the microphone array may vary. For example, the position of an acoustic transducer 1220 may include a defined position on the user, a defined coordinate on frame 1210, an orientation associated with each acoustic transducer 1220, or some combination thereof.

Acoustic transducers 1220(A) and 1220(B) may be positioned on different parts of the user's ear, such as behind the pinna, behind the tragus, and/or within the auricle or fossa. Or, there may be additional acoustic transducers 1220 on or surrounding the ear in addition to acoustic transducers 1220 inside the ear canal. Having an acoustic transducer 1220 positioned next to an ear canal of a user may enable the microphone array to collect information on how sounds arrive at the ear canal. By positioning at least two of acoustic transducers 1220 on either side of a user's head (e.g., as binaural microphones), augmented-reality device 1200 may simulate binaural hearing and capture a 3D stereo sound field around about a user's head. In some embodiments, acoustic transducers 1220(A) and 1220(B) may be connected to augmented-reality system 1200 via a wired connection 1230, and in other embodiments acoustic transducers 1220(A) and 1220(B) may be connected to augmented-reality system 1200 via a wireless connection (e.g., a BLUETOOTH connection). In still other embodiments, acoustic transducers 1220(A) and 1220(B) may not be used at all in conjunction with augmented-reality system 1200.

Acoustic transducers 1220 on frame 1210 may be positioned in a variety of different ways, including along the length of the temples, across the bridge, above or below display devices 1215(A) and 1215(B), or some combination thereof. Acoustic transducers 1220 may also be oriented such that the microphone array is able to detect sounds in a wide range of directions surrounding the user wearing the augmented-reality system 1200. In some embodiments, an optimization process may be performed during manufacturing of augmented-reality system 1200 to determine relative positioning of each acoustic transducer 1220 in the microphone array.

In some examples, augmented-reality system 1200 may include or be connected to an external device (e.g., a paired device), such as neckband 1205. Neckband 1205 generally represents any type or form of paired device. Thus, the following discussion of neckband 1205 may also apply to various other paired devices, such as charging cases, smart watches, smart phones, wrist bands, other wearable devices, hand-held controllers, tablet computers, laptop computers, other external compute devices, etc.

As shown, neckband 1205 may be coupled to eyewear device 1202 via one or more connectors. The connectors may be wired or wireless and may include electrical and/or non-electrical (e.g., structural) components. In some cases, eyewear device 1202 and neckband 1205 may operate independently without any wired or wireless connection between them. While FIG. 12 illustrates the components of eyewear device 1202 and neckband 1205 in example locations on eyewear device 1202 and neckband 1205, the components may be located elsewhere and/or distributed differently on eyewear device 1202 and/or neckband 1205. In some embodiments, the components of eyewear device 1202 and neckband 1205 may be located on one or more additional peripheral devices paired with eyewear device 1202, neckband 1205, or some combination thereof.

Pairing external devices, such as neckband 1205, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1200 may be provided by a paired device or shared between a paired device and an eyewear device, thus reducing the weight, heat profile, and form factor of the eyewear device overall while still retaining desired functionality. For example, neckband 1205 may allow components that would otherwise be included on an eyewear device to be included in neckband 1205 since users may tolerate a heavier weight load on their shoulders than they would tolerate on their heads. Neckband 1205 may also have a larger surface area over which to diffuse and disperse heat to the ambient environment. Thus, neckband 1205 may allow for greater battery and computation capacity than might otherwise have been possible on a stand-alone eyewear device. Since weight carried in neckband 1205 may be less invasive to a user than weight carried in eyewear device 1202, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1205 may be communicatively coupled with eyewear device 1202 and/or to other devices. These other devices may provide certain functions (e.g., tracking, localizing, depth mapping, processing, storage, etc.) to augmented-reality system 1200. In the embodiment of FIG. 12, neckband 1205 may include two acoustic transducers (e.g., 1220(I) and 1220(J)) that are part of the microphone array (or potentially form their own microphone subarray). Neckband 1205 may also include a controller 1225 and a power source 1235.

Acoustic transducers 1220(I) and 1220(J) of neckband 1205 may be configured to detect sound and convert the detected sound into an electronic format (analog or digital). In the embodiment of FIG. 12, acoustic transducers 1220(I) and 1220(J) may be positioned on neckband 1205, thereby increasing the distance between the neckband acoustic transducers 1220(I) and 1220(J) and other acoustic transducers 1220 positioned on eyewear device 1202. In some cases, increasing the distance between acoustic transducers 1220 of the microphone array may improve the accuracy of beamforming performed via the microphone array. For example, if a sound is detected by acoustic transducers 1220(C) and 1220(D) and the distance between acoustic transducers 1220(C) and 1220(D) is greater than, e.g., the distance between acoustic transducers 1220(D) and 1220(E), the determined source location of the detected sound may be more accurate than if the sound had been detected by acoustic transducers 1220(D) and 1220(E).

Controller 1225 of neckband 1205 may process information generated by the sensors on neckband 1205 and/or augmented-reality system 1200. For example, controller 1225 may process information from the microphone array that describes sounds detected by the microphone array. For each detected sound, controller 1225 may perform a direction-of-arrival (DOA) estimation to estimate a direction from which the detected sound arrived at the microphone array. As the microphone array detects sounds, controller 1225 may populate an audio data set with the information. In embodiments in which augmented-reality system 1200 includes an inertial measurement unit, controller 1225 may compute all inertial and spatial calculations from the IMU located on eyewear device 1202. A connector may convey information between augmented-reality system 1200 and neckband 1205 and between augmented-reality system 1200 and controller 1225. The information may be in the form of optical data, electrical data, wireless data, or any other transmittable data form. Moving the processing of information generated by augmented-reality system 1200 to neckband 1205 may reduce weight and heat in eyewear device 1202, making it more comfortable to the user.

Power source 1235 in neckband 1205 may provide power to eyewear device 1202 and/or to neckband 1205. Power source 1235 may include, without limitation, lithium-ion batteries, lithium-polymer batteries, primary lithium batteries, alkaline batteries, or any other form of power storage. In some cases, power source 1235 may be a wired power source. Including power source 1235 on neckband 1205 instead of on eyewear device 1202 may help better distribute the weight and heat generated by power source 1235.

As noted, some artificial-reality systems may instead of blending an artificial reality with actual reality, substantially replace one or more of a user's sensory perceptions of the real world with a virtual experience. One example of this type of system is a head-worn display system, such as virtual-reality system 1300 in FIG. 13, that mostly or completely covers a user's field of view. Virtual-reality system 1300 may include a front rigid body 1302 and a band 1304 shaped to fit around a user's head. Virtual-reality system 1300 may also include output audio transducers 1306(A) and 1306(B). Furthermore, while not shown in FIG. 13, front rigid body 1302 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1200 and/or virtual-reality system 1300 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1200 and/or virtual-reality system 1300 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1200 and/or virtual-reality system 1300 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

Some augmented-reality systems may map a user's and/or device's environment using techniques referred to as “simultaneous location and mapping” (SLAM). SLAM mapping and location identifying techniques may involve a variety of hardware and software tools that can create or update a map of an environment while simultaneously keeping track of a user's location within the mapped environment. SLAM may use many different types of sensors to create a map and determine a user's position within the map.

SLAM techniques may for example, implement optical sensors to determine a user's location. Radios including WiFi, BLUETOOTH, global positioning system (GPS), cellular or other communication devices may be also used to determine a user's location relative to a radio transceiver or group of transceivers (e.g., a WiFi router or group of GPS satellites). Acoustic sensors such as microphone arrays or 2D or 3D sonar sensors may also be used to determine a user's location within an environment. Augmented-reality and virtual-reality devices (such as systems 100 and 200 of FIG. 1 and FIG. 2, respectively) may incorporate any or all of these types of sensors to perform SLAM operations such as creating and continually updating maps of the user's current environment. In at least some of the embodiments described herein, SLAM data generated by these sensors may be referred to as “environmental data” and may indicate a user's current environment. This data may be stored in a local or remote data store (e.g., a cloud data store) and may be provided to a user's AR/VR device on demand.

When the user is wearing an augmented-reality headset or virtual-reality headset in a given environment, the user may be interacting with other users or other electronic devices that serve as audio sources. In some cases, it may be desirable to determine where the audio sources are located relative to the user and then present the audio sources to the user as if they were coming from the location of the audio source. The process of determining where the audio sources are located relative to the user may be referred to as “localization,” and the process of rendering playback of the audio source signal to appear as if it is coming from a specific direction may be referred to as “spatialization.”

Localizing an audio source may be performed in a variety of different ways. In some cases, an augmented-reality or virtual-reality headset may initiate a DOA analysis to determine the location of a sound source. The DOA analysis may include analyzing the intensity, spectra, and/or arrival time of each sound at the artificial-reality device to determine the direction from which the sounds originated. The DOA analysis may include any suitable algorithm for analyzing the surrounding acoustic environment in which the artificial-reality device is located.

For example, the DOA analysis may be designed to receive input signals from a microphone and apply digital signal processing algorithms to the input signals to estimate the direction of arrival. These algorithms may include, for example, delay and sum algorithms where the input signal is sampled, and the resulting weighted and delayed versions of the sampled signal are averaged together to determine a direction of arrival. A least mean squared (LMS) algorithm may also be implemented to create an adaptive filter. This adaptive filter may then be used to identify differences in signal intensity, for example, or differences in time of arrival. These differences may then be used to estimate the direction of arrival. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct-path audio signal. Those bins having a portion of the direct-path signal may then be analyzed to identify the angle at which a microphone array received the direct-path audio signal. The determined angle may then be used to identify the direction of arrival for the received input signal. Other algorithms not listed above may also be used alone or in combination with the above algorithms to determine DOA.

In some embodiments, different users may perceive the source of a sound as coming from slightly different locations. This may be the result of each user having a unique head-related transfer function (HRTF), which may be dictated by a user's anatomy including ear canal length and the positioning of the ear drum. The artificial-reality device may provide an alignment and orientation guide, which the user may follow to customize the sound signal presented to the user based on their unique HRTF. In some embodiments, an artificial-reality device may implement one or more microphones to listen to sounds within the user's environment. The augmented-reality or virtual-reality headset may use a variety of different array transfer functions (e.g., any of the DOA algorithms identified above) to estimate the direction of arrival for the sounds. Once the direction of arrival has been determined, the artificial-reality device may play back sounds to the user according to the user's unique HRTF. Accordingly, the DOA estimation generated using the array transfer function (ATF) may be used to determine the direction from which the sounds are to be played from. The playback sounds may be further refined based on how that specific user hears sounds according to the HRTF.

In addition to or as an alternative to performing a DOA estimation, an artificial-reality device may perform localization based on information received from other types of sensors. These sensors may include cameras, IR sensors, heat sensors, motion sensors, GPS receivers, or in some cases, sensors that detect a user's eye movements. For example, as noted above, an artificial-reality device may include an eye tracker or gaze detector that determines where the user is looking. Often, the user's eyes will look at the source of the sound, if only briefly. Such clues provided by the user's eyes may further aid in determining the location of a sound source. Other sensors such as cameras, heat sensors, and IR sensors may also indicate the location of a user, the location of an electronic device, or the location of another sound source. Any or all of the above methods may be used individually or in combination to determine the location of a sound source and may further be used to update the location of a sound source over time.

Some embodiments may implement the determined DOA to generate a more customized output audio signal for the user. For instance, an “acoustic transfer function” may characterize or define how a sound is received from a given location. More specifically, an acoustic transfer function may define the relationship between parameters of a sound at its source location and the parameters by which the sound signal is detected (e.g., detected by a microphone array or detected by a user's ear). An artificial-reality device may include one or more acoustic sensors that detect sounds within range of the device. A controller of the artificial-reality device may estimate a DOA for the detected sounds (using, e.g., any of the methods identified above) and, based on the parameters of the detected sounds, may generate an acoustic transfer function that is specific to the location of the device. This customized acoustic transfer function may thus be used to generate a spatialized output audio signal where the sound is perceived as coming from a specific location.

Indeed, once the location of the sound source or sources is known, the artificial-reality device may re-render (i.e., spatialize) the sound signals to sound as if coming from the direction of that sound source. The artificial-reality device may apply filters or other digital signal processing that alter the intensity, spectra, or arrival time of the sound signal. The digital signal processing may be applied in such a way that the sound signal is perceived as originating from the determined location. The artificial-reality device may amplify or subdue certain frequencies or change the time that the signal arrives at each ear. In some cases, the artificial-reality device may create an acoustic transfer function that is specific to the location of the device and the detected direction of arrival of the sound signal. In some embodiments, the artificial-reality device may re-render the source signal in a stereo device or multi-speaker device (e.g., a surround sound device). In such cases, separate and distinct audio signals may be sent to each speaker. Each of these audio signals may be altered according to the user's HRTF and according to measurements of the user's location and the location of the sound source to sound as if they are coming from the determined location of the sound source. Accordingly, in this manner, the artificial-reality device (or speakers associated with the device) may re-render an audio signal to sound as if originating from a specific location.

As noted, artificial-reality systems 1200 and 1300 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

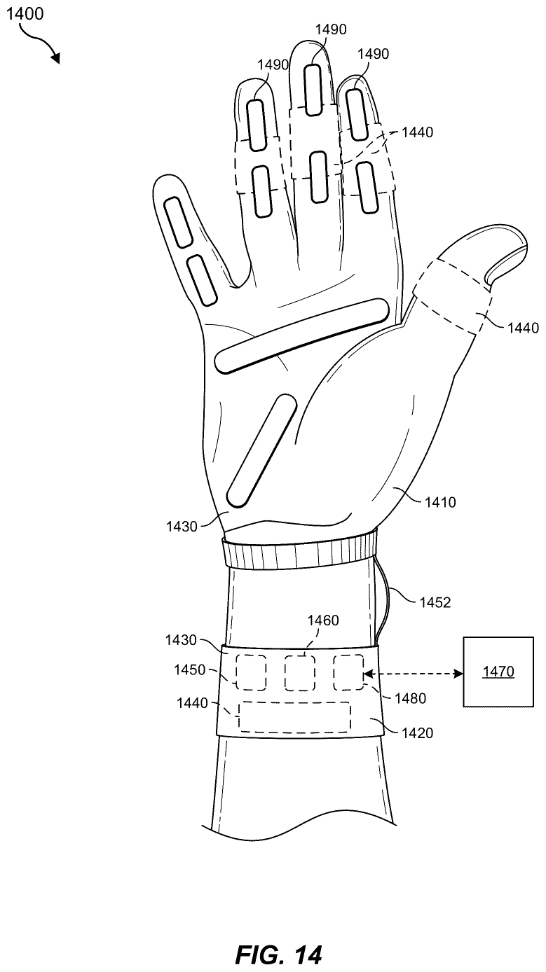

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 14 illustrates a vibrotactile system 1400 in the form of a wearable glove (haptic device 1410) and wristband (haptic device 1420). Haptic device 1410 and haptic device 1420 are shown as examples of wearable devices that include a flexible, wearable textile material 1430 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 1440 may be positioned at least partially within one or more corresponding pockets formed in textile material 1430 of vibrotactile system 1400. Vibrotactile devices 1440 may be positioned in locations to provide a vibrating sensation (e.g., haptic feedback) to a user of vibrotactile system 1400. For example, vibrotactile devices 1440 may be positioned against the user's finger(s), thumb, or wrist, as shown in FIG. 14. Vibrotactile devices 1440 may, in some examples, be sufficiently flexible to conform to or bend with the user's corresponding body part(s).

A power source 1450 (e.g., a battery) for applying a voltage to the vibrotactile devices 1440 for activation thereof may be electrically coupled to vibrotactile devices 1440, such as via conductive wiring 1452. In some examples, each of vibrotactile devices 1440 may be independently electrically coupled to power source 1450 for individual activation. In some embodiments, a processor 1460 may be operatively coupled to power source 1450 and configured (e.g., programmed) to control activation of vibrotactile devices 1440.

Vibrotactile system 1400 may be implemented in a variety of ways. In some examples, vibrotactile system 1400 may be a standalone system with integral subsystems and components for operation independent of other devices and systems. As another example, vibrotactile system 1400 may be configured for interaction with another device or system 1470. For example, vibrotactile system 1400 may, in some examples, include a communications interface 1480 for receiving and/or sending signals to the other device or system 1470. The other device or system 1470 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 1480 may enable communications between vibrotactile system 1400 and the other device or system 1470 via a wireless (e.g., Wi-Fi, BLUETOOTH, cellular, radio, etc.) link or a wired link. If present, communications interface 1480 may be in communication with processor 1460, such as to provide a signal to processor 1460 to activate or deactivate one or more of the vibrotactile devices 1440.

Vibrotactile system 1400 may optionally include other subsystems and components, such as touch-sensitive pads 1490, pressure sensors, motion sensors, position sensors, lighting elements, and/or user interface elements (e.g., an on/off button, a vibration control element, etc.). During use, vibrotactile devices 1440 may be configured to be activated for a variety of different reasons, such as in response to the user's interaction with user interface elements, a signal from the motion or position sensors, a signal from the touch-sensitive pads 1490, a signal from the pressure sensors, a signal from the other device or system 1470, etc.

Although power source 1450, processor 1460, and communications interface 1480 are illustrated in FIG. 14 as being positioned in haptic device 1420, the present disclosure is not so limited. For example, one or more of power source 1450, processor 1460, or communications interface 1480 may be positioned within haptic device 1410 or within another wearable textile.

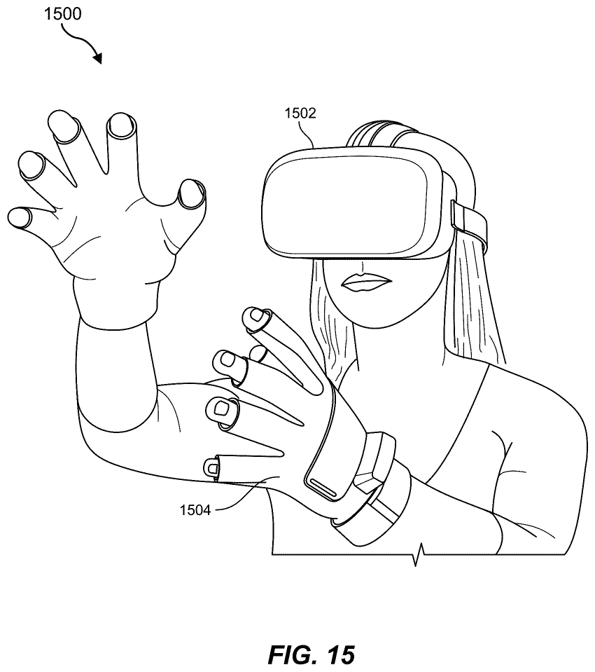

Haptic wearables, such as those shown in and described in connection with FIG. 14, may be implemented in a variety of types of artificial-reality systems and environments. FIG. 15 shows an example artificial-reality environment 1500 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1502 generally represents any type or form of virtual-reality system, such as virtual-reality system 1300 in FIG. 13. Haptic device 1504 generally represents any type or form of wearable device, worn by a user of an artificial-reality system, that provides haptic feedback to the user to give the user the perception that he or she is physically engaging with a virtual object. In some embodiments, haptic device 1504 may provide haptic feedback by applying vibration, motion, and/or force to the user. For example, haptic device 1504 may limit or augment a user's movement. To give a specific example, haptic device 1504 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 1504 to send action requests to a console. Examples of action requests include, without limitation, requests to start an application and/or end the application and/or requests to perform a particular action within the application.

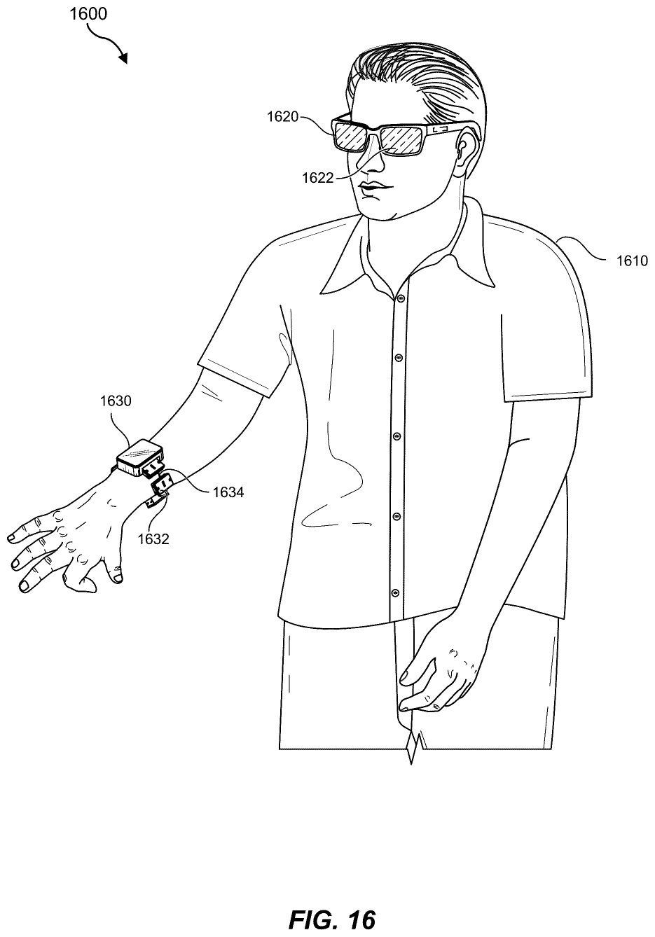

While haptic interfaces may be used with virtual-reality systems, as shown in FIG. 15, haptic interfaces may also be used with augmented-reality systems, as shown in FIG. 16. FIG. 16 is a perspective view of a user 1610 interacting with an augmented-reality system 1600. In this example, user 1610 may wear a pair of augmented-reality glasses 1620 that may have one or more displays 1622 and that are paired with a haptic device 1630. In this example, haptic device 1630 may be a wristband that includes a plurality of band elements 1632 and a tensioning mechanism 1634 that connects band elements 1632 to one another.

One or more of band elements 1632 may include any type or form of actuator suitable for providing haptic feedback. For example, one or more of band elements 1632 may be configured to provide one or more of various types of cutaneous feedback, including vibration, force, traction, texture, and/or temperature. To provide such feedback, band elements 1632 may include one or more of various types of actuators. In one example, each of band elements 1632 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 1410, 1420, 1504, and 1630 may include any suitable number and/or type of haptic transducer, sensor, and/or feedback mechanism. For example, haptic devices 1410, 1420, 1504, and 1630 may include one or more mechanical transducers, piezoelectric transducers, and/or fluidic transducers. Haptic devices 1410, 1420, 1504, and 1630 may also include various combinations of different types and forms of transducers that work together or independently to enhance a user's artificial-reality experience. In one example, each of band elements 1632 of haptic device 1630 may include a vibrotactor (e.g., a vibrotactile actuator) configured to vibrate in unison or independently to provide one or more of various types of haptic sensations to a user.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

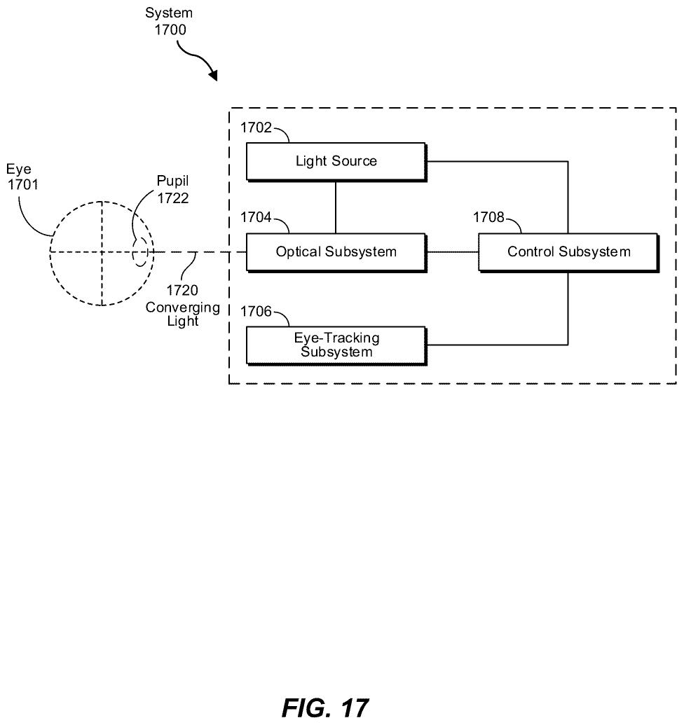

FIG. 17 is an illustration of an exemplary system 1700 that incorporates an eye-tracking subsystem capable of tracking a user's eye(s). As depicted in FIG. 17, system 1700 may include a light source 1702, an optical subsystem 1704, an eye-tracking subsystem 1706, and/or a control subsystem 1708. In some examples, light source 1702 may generate light for an image (e.g., to be presented to an eye 1701 of the viewer). Light source 1702 may represent any of a variety of suitable devices. For example, light source 1702 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 1704 may receive the light generated by light source 1702 and generate, based on the received light, converging light 1720 that includes the image. In some examples, optical subsystem 1704 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 1720. Further, various mechanical couplings may serve to maintain the relative spacing and/or the orientation of the optical components in any suitable combination.

In one embodiment, eye-tracking subsystem 1706 may generate tracking information indicating a gaze angle of an eye 1701 of the viewer. In this embodiment, control subsystem 1708 may control aspects of optical subsystem 1704 (e.g., the angle of incidence of converging light 1720) based at least in part on this tracking information. Additionally, in some examples, control subsystem 1708 may store and utilize historical tracking information (e.g., a history of the tracking information over a given duration, such as the previous second or fraction thereof) to anticipate the gaze angle of eye 1701 (e.g., an angle between the visual axis and the anatomical axis of eye 1701). In some embodiments, eye-tracking subsystem 1706 may detect radiation emanating from some portion of eye 1701 (e.g., the cornea, the iris, the pupil, or the like) to determine the current gaze angle of eye 1701. In other examples, eye-tracking subsystem 1706 may employ a wavefront sensor to track the current location of the pupil.

Any number of techniques can be used to track eye 1701. Some techniques may involve illuminating eye 1701 with infrared light and measuring reflections with at least one optical sensor that is tuned to be sensitive to the infrared light. Information about how the infrared light is reflected from eye 1701 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 1706 may be digitized (i.e., converted to an electronic signal). Further, the sensor may transmit a digital representation of this electronic signal to one or more processors (for example, processors associated with a device including eye-tracking subsystem 1706). Eye-tracking subsystem 1706 may include any of a variety of sensors in a variety of different configurations. For example, eye-tracking subsystem 1706 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 1706 to track the movement of eye 1701. In another example, these processors may track the movements of eye 1701 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 1706 may be programmed to use an output of the sensor(s) to track movement of eye 1701. In some embodiments, eye-tracking subsystem 1706 may analyze the digital representation generated by the sensors to extract eye rotation information from changes in reflections. In one embodiment, eye-tracking subsystem 1706 may use corneal reflections or glints (also known as Purkinje images) and/or the center of the eye's pupil 1722 as features to track over time.

In some embodiments, eye-tracking subsystem 1706 may use the center of the eye's pupil 1722 and infrared or near-infrared, non-collimated light to create corneal reflections. In these embodiments, eye-tracking subsystem 1706 may use the vector between the center of the eye's pupil 1722 and the corneal reflections to compute the gaze direction of eye 1701. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 1706 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 1701 may act as a retroreflector as the light reflects off the retina, thereby creating a bright pupil effect similar to a red-eye effect in photography. If the illumination source is offset from the optical path, then the eye's pupil 1722 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 1708 may control light source 1702 and/or optical subsystem 1704 to reduce optical aberrations (e.g., chromatic aberrations and/or monochromatic aberrations) of the image that may be caused by or influenced by eye 1701. In some examples, as mentioned above, control subsystem 1708 may use the tracking information from eye-tracking subsystem 1706 to perform such control. For example, in controlling light source 1702, control subsystem 1708 may alter the light generated by light source 1702 (e.g., by way of image rendering) to modify (e.g., pre-distort) the image so that the aberration of the image caused by eye 1701 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

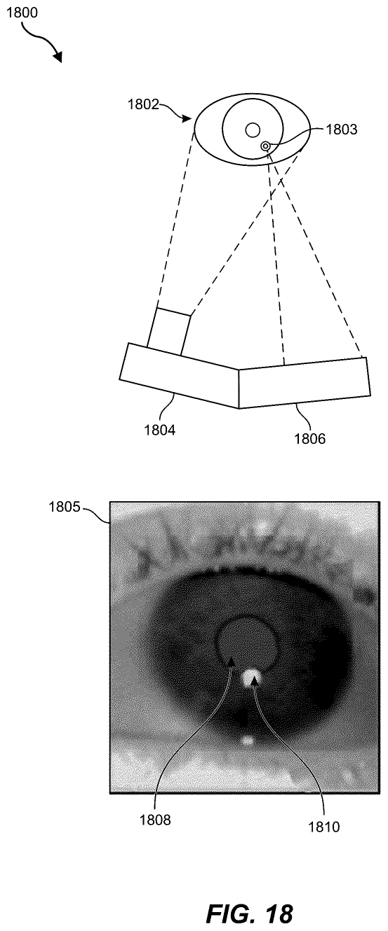

FIG. 18 is a more detailed illustration of various aspects of the eye-tracking subsystem illustrated in FIG. 17. As shown in this figure, an eye-tracking subsystem 1800 may include at least one source 1804 and at least one sensor 1806. Source 1804 generally represents any type or form of element capable of emitting radiation. In one example, source 1804 may generate visible, infrared, and/or near-infrared radiation. In some examples, source 1804 may radiate non-collimated infrared and/or near-infrared portions of the electromagnetic spectrum towards an eye 1802 of a user. Source 1804 may utilize a variety of sampling rates and speeds. For example, the disclosed systems may use sources with higher sampling rates in order to capture fixational eye movements of a user's eye 1802 and/or to correctly measure saccade dynamics of the user's eye 1802. As noted above, any type or form of eye-tracking technique may be used to track the user's eye 1802, including optical-based eye-tracking techniques, ultrasound-based eye-tracking techniques, etc.

Sensor 1806 generally represents any type or form of element capable of detecting radiation, such as radiation reflected off the user's eye 1802. Examples of sensor 1806 include, without limitation, a charge coupled device (CCD), a photodiode array, a complementary metal-oxide-semiconductor (CMOS) based sensor device, and/or the like. In one example, sensor 1806 may represent a sensor having predetermined parameters, including, but not limited to, a dynamic resolution range, linearity, and/or other characteristic selected and/or designed specifically for eye tracking.

As detailed above, eye-tracking subsystem 1800 may generate one or more glints. As detailed above, a glint 1803 may represent reflections of radiation (e.g., infrared radiation from an infrared source, such as source 1804) from the structure of the user's eye. In various embodiments, glint 1803 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 18 shows an example image 1805 captured by an eye-tracking subsystem, such as eye-tracking subsystem 1800. In this example, image 1805 may include both the user's pupil 1808 and a glint 1810 near the same. In some examples, pupil 1808 and/or glint 1810 may be identified using an artificial-intelligence-based algorithm, such as a computer-vision-based algorithm. In one embodiment, image 1805 may represent a single frame in a series of frames that may be analyzed continuously in order to track the eye 1802 of the user. Further, pupil 1808 and/or glint 1810 may be tracked over a period of time to determine a user's gaze.

In one example, eye-tracking subsystem 1800 may be configured to identify and measure the inter-pupillary distance (IPD) of a user. In some embodiments, eye-tracking subsystem 1800 may measure and/or calculate the IPD of the user while the user is wearing the artificial reality system. In these embodiments, eye-tracking subsystem 1800 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 1700 and/or eye-tracking subsystem 1800 may be incorporated into augmented-reality system 1200 in FIG. 12 and/or virtual-reality system 1300 in FIG. 13 to enable these systems to perform various eye-tracking tasks (including one or more of the eye-tracking operations described herein).

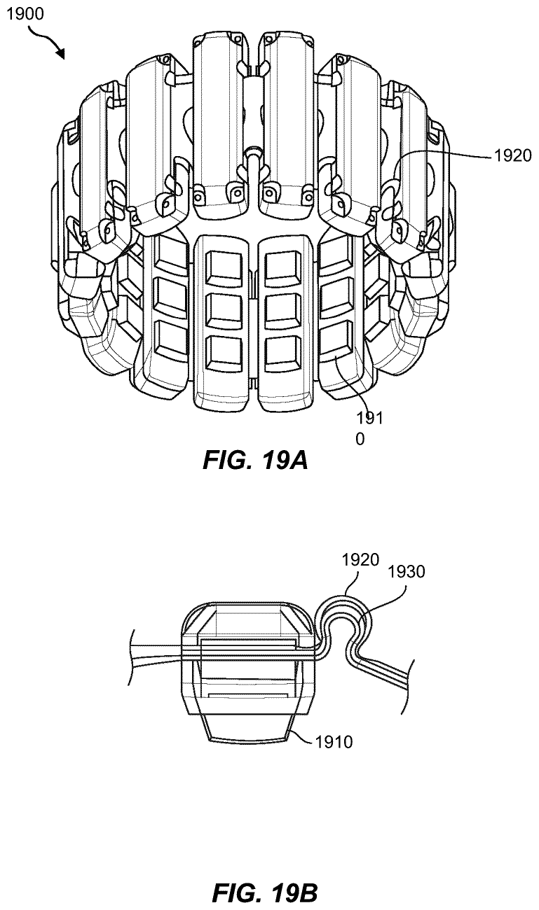

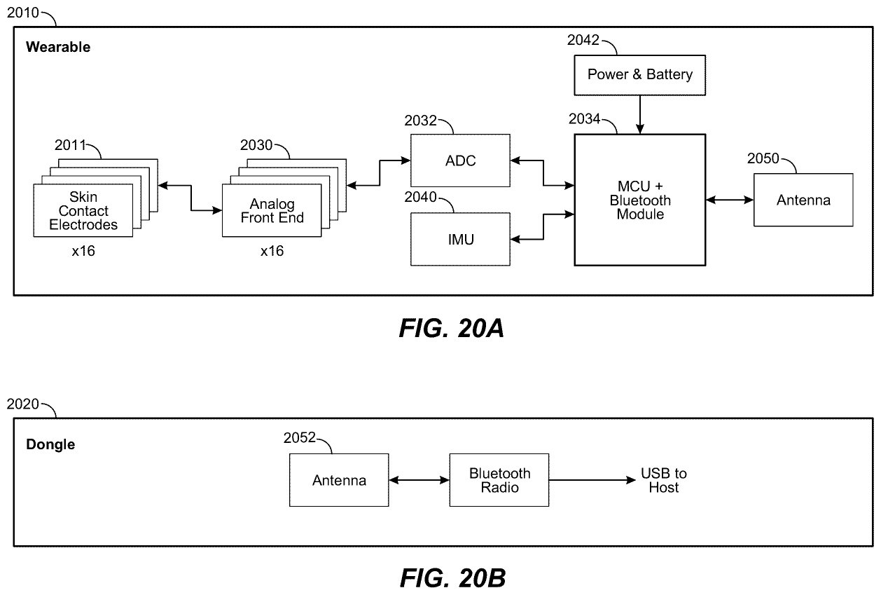

FIG. 19A illustrates an exemplary human-machine interface (also referred to herein as an EMG control interface) configured to be worn around a user's lower arm or wrist as a wearable system 1900. In this example, wearable system 1900 may include sixteen neuromuscular sensors 1910 (e.g., EMG sensors) arranged circumferentially around an elastic band 1920 with an interior surface 1930 configured to contact a user's skin. However, any suitable number of neuromuscular sensors may be used. The number and arrangement of neuromuscular sensors may depend on the particular application for which the wearable device is used. For example, a wearable armband or wristband can be used to generate control information for controlling an augmented reality system, a robot, controlling a vehicle, scrolling through text, controlling a virtual avatar, or any other suitable control task. As shown, the sensors may be coupled together using flexible electronics incorporated into the wireless device. FIG. 19B illustrates a cross-sectional view through one of the sensors of the wearable device shown in FIG. 19A. In some embodiments, the output of one or more of the sensing components can be optionally processed using hardware signal processing circuitry (e.g., to perform amplification, filtering, and/or rectification). In other embodiments, at least some signal processing of the output of the sensing components can be performed in software. Thus, signal processing of signals sampled by the sensors can be performed in hardware, software, or by any suitable combination of hardware and software, as aspects of the technology described herein are not limited in this respect. A non-limiting example of a signal processing chain used to process recorded data from sensors 1910 is discussed in more detail below with reference to FIGS. 20A and 20B.

FIGS. 20A and 20B illustrate an exemplary schematic diagram with internal components of a wearable system with EMG sensors. As shown, the wearable system may include a wearable portion 2010 (FIG. 20A) and a dongle portion 2020 (FIG. 20B) in communication with the wearable portion 2010 (e.g., via BLUETOOTH or another suitable wireless communication technology). As shown in FIG. 20A, the wearable portion 2010 may include skin contact electrodes 2011, examples of which are described in connection with FIGS. 19A and 19B. The output of the skin contact electrodes 2011 may be provided to analog front end 2030, which may be configured to perform analog processing (e.g., amplification, noise reduction, filtering, etc.) on the recorded signals. The processed analog signals may then be provided to analog-to-digital converter 2032, which may convert the analog signals to digital signals that can be processed by one or more computer processors. An example of a computer processor that may be used in accordance with some embodiments is microcontroller (MCU) 2034, illustrated in FIG. 20A. As shown, MCU 2034 may also include inputs from other sensors (e.g., IMU sensor 2040), and power and battery module 2042. The output of the processing performed by MCU 2034 may be provided to antenna 2050 for transmission to dongle portion 2020 shown in FIG. 20B.

Dongle portion 2020 may include antenna 2052, which may be configured to communicate with antenna 2050 included as part of wearable portion 2010. Communication between antennas 2050 and 2052 may occur using any suitable wireless technology and protocol, non-limiting examples of which include radiofrequency signaling and BLUETOOTH. As shown, the signals received by antenna 2052 of dongle portion 2020 may be provided to a host computer for further processing, display, and/or for effecting control of a particular physical or virtual object or objects.

Although the examples provided with reference to FIGS. 19A-19B and FIGS. 20A-20B are discussed in the context of interfaces with EMG sensors, the techniques described herein for reducing electromagnetic interference can also be implemented in wearable interfaces with other types of sensors including, but not limited to, mechanomyography (MMG) sensors, sonomyography (SMG) sensors, and electrical impedance tomography (EIT) sensors. The techniques described herein for reducing electromagnetic interference can also be implemented in wearable interfaces that communicate with computer hosts through wires and cables (e.g., USB cables, optical fiber cables, etc.).

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A circuitry-implemented method comprising:
receiving an image pyramid of an image;
convolving each level of the image pyramid with a kernel;
constructing, based at least in part on the convolving of each level of the image pyramid, a base image pyramid; and
generating a detail layer of the image by subtracting, from the image, a selected level of the base image pyramid from the image.

2. The circuitry-implemented method of claim 1, wherein:
a noise reduction module previously used the image pyramid to perform a noise reduction operation; and
receiving the image pyramid comprises receiving the image pyramid from the noise reduction module without regenerating the image pyramid.

3. The circuitry-implemented method of claim 1, wherein constructing the base image pyramid comprises:
using a convolved initial level of the image pyramid as an initial level of the base image pyramid; and
for each successive additional level of the base image pyramid, merging a corresponding convolved level of the image pyramid with an upscaled version of a previous level of the base image pyramid.

4. The circuitry-implemented method of claim 1, wherein the image pyramid comprises a Gaussian pyramid.

5. The circuitry-based method of claim 1, wherein the image pyramid comprises a luma pyramid of the image.

6. The circuitry-based method of claim 1, further comprising:
receiving an additional image pyramid of an additional image;
in response to detecting a low-power mode, convolving a subset of levels of the additional image pyramid with the kernel;
constructing, based at least in part on the convolving of the subset of levels of the additional image pyramid, an additional base image pyramid; and
generating a detail layer of the image by subtracting, from the image, a selected level of the base image pyramid from the image.

7. The circuitry-based method of claim 1, further comprising generating an enhanced image with an increased level of detail by applying the detail layer to the image.

8. The circuitry-based method of claim 7,
further comprising transmitting the image to a color correction module that enhances the image by applying color correction to the image.

9. The circuitry-based method of claim 8, further comprising transmitting the detail layer directly to a tone-mapping module by bypassing the color correction module, wherein the tone-mapping module:
receives the image as enhanced by the color correction module;
applies a tone-mapping process to the image to further enhance the image; and
applies the detail layer after the tone-mapping process to further enhance the image.

10. A device comprising:
circuitry configured to:
receive an image pyramid of an image;
convolve each level of the image pyramid with a kernel;
construct, based at least in part on the convolving of each level of the image pyramid, a base image pyramid; and
generate a detail layer of the image by subtracting, from the image, a selected level of the base image pyramid from the image.

11. The device of claim 10, wherein:
a noise reduction module previously used the image pyramid to perform a noise reduction operation; and
receiving the image pyramid comprises receiving the image pyramid from the noise reduction module without regenerating the image pyramid.

12. The device of claim 10, wherein constructing the base image pyramid comprises:
using a convolved initial level of the image pyramid as an initial level of the base image pyramid; and
for each successive additional level of the base image pyramid, merging a corresponding convolved level of the image pyramid with an upscaled version of a previous level of the base image pyramid.

13. The device of claim 10, wherein the image pyramid comprises a Gaussian pyramid.

14. The device of claim 10, wherein the image pyramid comprises a luma pyramid of the image.

15. The device of claim 10, the circuitry being further configured to:
receive an additional image pyramid of an additional image;
in response to detecting a low-power mode, convolve a subset of levels of the additional image pyramid with the kernel;
construct, based at least in part on the convolving of the subset of levels of the additional image pyramid, an additional base image pyramid; and
generate a detail layer of the image by subtracting, from the image, a selected level of the base image pyramid from the image.

16. The device of claim 10, the circuitry being further configured to generate an enhanced image with an increased level of detail by applying the detail layer to the image.

17. The device of claim 16, the circuitry being further configured to transmit the image to a color correction module that enhances the image by applying color correction to the image.

18. The device of claim 17, the circuitry being further configured to transmit the detail layer directly to a tone-mapping module by bypassing the color correction module, wherein the tone-mapping module:
receives the image as enhanced by the color correction module;
applies a tone-mapping process to the image to further enhance the image; and
applies the detail layer after the tone-mapping process to further enhance the image.

19. A system comprising:
a head-mounted display; and
circuitry configured to:
receive an image pyramid of an image;
convolve each level of the image pyramid with a kernel;
construct, based at least in part on the convolving of each level of the image pyramid, a base image pyramid;
generate a detail layer of the image by subtracting, from the image, a selected level of the base image pyramid from the image, wherein the detail layer is used to generate a display version of the image for the head-mounted display.

20. The system of claim 19, wherein:
a noise reduction module previously used the image pyramid to perform a noise reduction operation; and
receiving the image pyramid comprises receiving the image pyramid from the noise reduction module without regenerating the image pyramid.
